(19) United States
(12) Patent Application Publication
(10) Pub. No.: US 2026/0164302 A1
(43) Pub. Date: Jun. 11, 2026

(54) TECHNIQUES FOR REDUCING REDUNDANCY IN CONTROL INFORMATION

(71) Applicant: QUALCOMM Incorporated, San Diego, CA (US)

(72) Inventors: Umesh PHUYAL, San Diego, CA (US); Bharat SHRESTHA, San Diego, CA (US); Masato KITAZOE, Hachiouji-shi (JP); Ozcan OZTURK, San Diego, CA (US)

(21) Appl. No.: 18/971,547

(22) Filed: Dec. 6, 2024

(51) Int. Cl. H04W 28/06; H04L 1/00; H04W 72/20

(52) U.S. Cl. CPC H04W 28/06; H04L 1/0029; H04W 72/20

(57) ABSTRACT

Methods, systems, and devices for wireless communications are described. In some examples, a user equipment may receive an encoded message including a first reduced format version of a control message including one or more parameters for configuring a wireless communication session. The first reduced format version may have a reduced payload compared to a non-reduced format version of the control message. The UE may generate a second reduced version format based on the non-reduced format version and a value of the one or more parameters. The UE may decode the full payload of the control message based on the second reduced version format, and the UE may communicate one or more messages based on the full payload of the control message.

### FIELD OF TECHNOLOGY

The following relates to wireless communications, including techniques for reducing redundancy in control information.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving an encoded message including a first reduced format version of a control message including one or more parameters for configuring a wireless communication session, where the first reduced format version has a reduced payload compared to a non-reduced format version of the control message, generating a second reduced format version based on the non-reduced format version and a value of the one or more parameters, where the second reduced format version has the reduced payload compared to the non-reduced format version, decoding a full payload of the control message based on the second reduced format version, and communicating one or more messages based on the full payload of the control message.

A UE for wireless communications is described. The UE may include one or more memories storing processor executable code, and one or more processors coupled with the one or more memories. The one or more processors may individually or collectively be operable to execute the code to cause the UE to receive an encoded message including a first reduced format version of a control message including one or more parameters for configuring a wireless communication session, where the first reduced format version has a reduced payload compared to a non-reduced format version of the control message, generate a second reduced format version based on the non-reduced format version and a value of the one or more parameters, where the second reduced format version has the reduced payload compared to the non-reduced format version, decode a full payload of the control message based on the second reduced format version, and communicate one or more messages based on the full payload of the control message.

Another UE for wireless communications is described. The UE may include means for receiving an encoded message including a first reduced format version of a control message including one or more parameters for configuring a wireless communication session, where the first reduced format version has a reduced payload compared to a non-reduced format version of the control message, means for generating a second reduced format version based on the non-reduced format version and a value of the one or more parameters, where the second reduced format version has the reduced payload compared to the non-reduced format version, means for decoding a full payload of the control message based on the second reduced format version, and means for communicating one or more messages based on the full payload of the control message.

A non-transitory computer-readable medium storing code for wireless communications is described. The code may include instructions executable by one or more processors to receive an encoded message including a first reduced format version of a control message including one or more parameters for configuring a wireless communication session, where the first reduced format version has a reduced payload compared to a non-reduced format version of the control message, generate a second reduced format version based on the non-reduced format version and a value of the one or more parameters, where the second reduced format version has the reduced payload compared to the non-reduced format version, decode a full payload of the control message based on the second reduced format version, and communicate one or more messages based on the full payload of the control message.

In some examples of the method, user equipment (UEs), and non-transitory computer-readable medium described herein, receiving the first reduced format version may include operations, features, means, or instructions for receiving the first reduced format version that includes a main list and a set of multiple extension lists, where the value of the one or more parameters indicates a quantity of elements in the main list and in each of the set of multiple extension lists, and where the value of the one or more parameters may be absent for the main list and for each of the set of multiple extension lists.

Some examples of the method, user equipment (UEs), and non-transitory computer-readable medium described herein may further include operations, features, means, or instructions for receiving, prior to generating the second reduced format version, a message indicating a configuration that indicates the value of the one or more parameters.

In some examples of the method, user equipment (UEs), and non-transitory computer-readable medium described herein, generating the second reduced format version may include operations, features, means, or instructions for generating the second reduced format version based on generating the main list and each of the set of multiple extension lists using the value of the one or more parameters.

In some examples of the method, user equipment (UEs), and non-transitory computer-readable medium described herein, receiving the first reduced format version may include operations, features, means, or instructions for receiving the first reduced format version that includes a main list and a set of multiple extension lists, where the value of the one or more parameters indicates a quantity of elements in the main list and in each of the set of multiple extension lists, and where the value of the one or more parameters may be present for the main list and the value of the one or more parameters may be absent for each of the set of multiple extension lists.

In some examples of the method, user equipment (UEs), and non-transitory computer-readable medium described herein, generating the second reduced format version may include operations, features, means, or instructions for generating the second reduced format version based on generating each of the set of multiple extension lists using the value of the one or more parameters.

In some examples of the method, user equipment (UEs), and non-transitory computer-readable medium described herein, receiving the first reduced format version may include operations, features, means, or instructions for receiving the first reduced format version that includes an original list and one or more concatenated extension lists, where the value of the one or more parameters indicates a quantity of elements in the original list and in each of the set of multiple concatenated extension lists, and where the value of the one or more parameters may be absent for the original list and for the one or more concatenated extension lists.

In some examples of the method, user equipment (UEs), and non-transitory computer-readable medium described herein, and the method, apparatuses, and non-transitory computer-readable medium may include further operations, features, means, or instructions for receiving, prior to generating the second reduced format version, a message indicating a configuration that indicates the value of the one or more parameters, and where generating the second reduced format version further includes and generating the second reduced format version based on generating the original list and each of the one or more concatenated extension lists using the value of the one or more parameters.

In some examples of the method, user equipment (UEs), and non-transitory computer-readable medium described herein, receiving the first reduced format version may include operations, features, means, or instructions for receiving the first reduced format version that includes an original list and one or more concatenated extension lists, where the value of the one or more parameters indicates a quantity of elements in the original list and in each of the set of multiple concatenated extension lists, and where the value of the one or more parameters may be absent for the one or more concatenated extension lists, where generating the second reduced format version further includes and generating the second reduced format version based on generating each of the one or more concatenated extension lists using the value of the one or more parameters.

In some examples of the method, user equipment (UEs), and non-transitory computer-readable medium described herein, the first reduced format version includes an abstract syntax notation one format.

In some examples of the method, user equipment (UEs), and non-transitory computer-readable medium described herein, the reduced payload includes a reduced header size compared to the non-reduced format version of the control message.

Some examples of the method, user equipment (UEs), and non-transitory computer-readable medium described herein may further include operations, features, means, or instructions for receiving, prior to communicating the one or more messages, side information indicating the value of the one or more parameters.

In some examples of the method, user equipment (UEs), and non-transitory computer-readable medium described herein, the side information includes an encoding control notation format or an abstract syntax notation one format.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for reducing redundancy in control information in accordance with one or more aspects of the present disclosure.

FIG. 2 shows an example of a wireless communications system that supports techniques for reducing redundancy in control information in accordance with one or more aspects of the present disclosure.

FIG. 3 shows an example of a block diagram that supports techniques for reducing redundancy in control information in accordance with one or more aspects of the present disclosure.

FIG. 4 shows an example of a process flow that supports techniques for reducing redundancy in control information in accordance with one or more aspects of the present disclosure.

FIGS. 5 and 6 show block diagrams of devices that support techniques for reducing redundancy in control information in accordance with one or more aspects of the present disclosure.

FIG. 7 shows a block diagram of a communications manager that supports techniques for reducing redundancy in control information in accordance with one or more aspects of the present disclosure.

FIG. 8 shows a diagram of a system including a device that supports techniques for reducing redundancy in control information in accordance with one or more aspects of the present disclosure.

FIGS. 9 and 10 show block diagrams of devices that support techniques for reducing redundancy in control information in accordance with one or more aspects of the present disclosure.

FIG. 11 shows a block diagram of a communications manager that supports techniques for reducing redundancy in control information in accordance with one or more aspects of the present disclosure.

FIG. 12 shows a diagram of a system including a device that supports techniques for reducing redundancy in control information in accordance with one or more aspects of the present disclosure.

FIGS. 13 through 15 show flowcharts illustrating methods that support techniques for reducing redundancy in control information in accordance with one or more aspects of the present disclosure.

### DETAILED DESCRIPTION

In some wireless communications systems, a network entity may communicate messages with a user equipment (UE). To coordinate the communications, the network entity may transmit, to the UE, a control message, and, in some cases, the control message may be a radio resource control (RRC) message. The RRC message may be encoded using an abstract syntax notation one (ASN.1) format. In some cases, the RRC message encoded using the ASN.1 format may include redundant information that creates overhead. For example, the RRC message may include variable size parallel lists and conditional presence and absence fields that contribute to redundancy in the ASN.1 headers. The parallel lists may include a main list and several extension lists, and the main list and the extension lists may include a size variable. The size variable is fixed for all members of the parallel list; however, the ASN.1 encoder may insert a fixed header to indicate the size variable for each of the members of the parallel list creating overhead. In some cases, configuration parameters may be defined as conditions in field descriptions or as conditional presence statements. For example, conditions in RRC configuration if satisfied may result in a field being absent, and the absence of the field in the signaling may be indicated by a presence flag being set to zero in the header resulting in overhead. There is a desire to reduce the overhead of the control message.

Techniques for reducing redundancy in control information may be employed. In some examples, the UE may receive, from the network entity, a reduced format version of a control message. The first reduced format version of the control message may include one or more parameters for configuring a wireless communication session. The first reduced format version of the control message may have a reduced content payload as compared to a non-reduced format version of the control message. The UE may reconstruct a second reduced format version based on the non-reduced format version and a value of the one or more parameters. The UE may decode the full content payload of the control message based on the second reduced format version. The UE may communicate messages based on the full content payload of the control message. In some examples, the UE may receive a configuration that indicates the value of the one or more parameters. In some cases, the first reduced format version may include a main list and a plurality of extension lists, and the value of the one or more parameters may indicate a quantity of elements in the main list and in each of the plurality of extension lists. In some cases, the value of the one or more parameters may be absent for the main list and for each of the plurality of extension lists.

Aspects of the disclosure are initially described in the context of wireless communications systems. Aspects of the disclosure are further illustrated by and described with reference to a block diagram, a process flow, apparatus diagrams, system diagrams, and flowcharts that relate to techniques for reducing redundancy in control information.

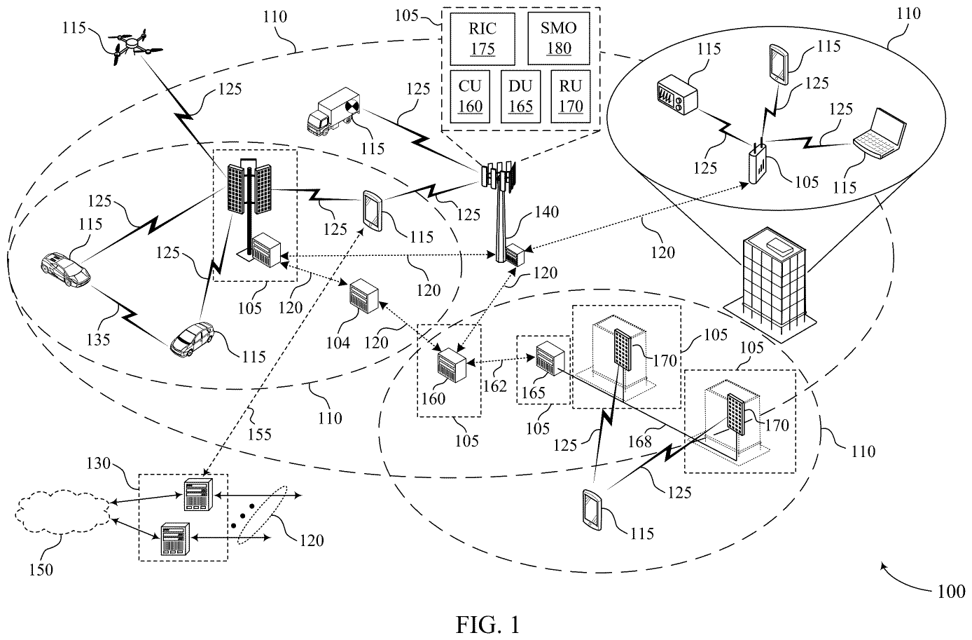

FIG. 1 shows an example of a wireless communications system 100 that supports techniques for reducing redundancy in control information in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for reducing redundancy in control information as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, the network entity 105 may communicate messages with the UE 115. To coordinate the communications, the network entity 105 may transmit, to the UE 115, a control message, and, in some cases, the control message may be a RRC message. The RRC message may be encoded using an ASN.1 format, although other formats are also possible. In some cases, the RRC message encoded using the ASN.1 format may include redundant information that creates overhead. For example, the RRC message may include variable size parallel lists and conditional presence and absence fields that contribute to redundancy in the ASN.1 headers. The parallel lists may include a main list and several extension lists, and the main list and the extension lists may include a size variable or other parameter. Even if the size variable is fixed for all members of the parallel list, the ASN.1 encoder may insert a fixed header or other parameter to indicate the size variable for each of the members of the parallel list, resulting in additional overhead. In some cases, configuration parameters may be defined as conditions in field descriptions or as conditional presence statements. For example, conditions in RRC configuration if satisfied may result in a field being absent, and the absence of the field in the signaling may be indicated by a presence flag being set to zero in the header resulting in overhead. There is a desire to reduce the overhead of the control message.

Techniques for reducing redundancy in control information may be employed. In some examples, the UE 115 may receive, from the network entity 105, an encoded message including a first reduced format version of a control message. The first reduced format version of the control message may include one or more parameters for configuring a wireless communication session. The first reduced format version of the control message may have a reduced content payload as compared to a non-reduced format version of the control message. For example, the first reduced format version of the control message may have a reduced amount of header information, a reduced amount of data payload information, or both, as compared to a non-reduced format version of the control message. The UE 115 may reconstruct a second non-reduced version based on the non-reduced format version and a value of the one or more parameters. The UE 115 may decode the full content payload of the control message based on the non-reduced version. The UE 115 may communicate messages based on the full content payload of the control message. In some examples, the UE 115 may receive a configuration that indicates the value of the one or more parameters. In some cases, the first reduced format version may include a main list and a plurality of extension lists, and the value of the one or more parameters may indicate a quantity of elements in the main list and in each of the plurality of extension lists. In some cases, the value of the one or more parameters may be absent for the main list and for each of the plurality of extension lists.

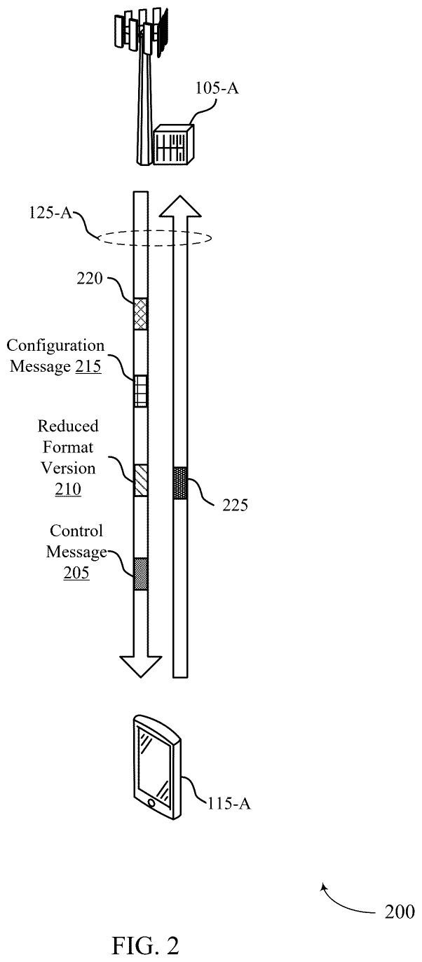

FIG. 2 shows an example of a wireless communications system 200 that supports techniques for reducing redundancy in control information in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a, which may be an example of a network entity 105 as described herein.

In some examples, the UE 115-a may communicate with the network entity 105-a using a communication link 125-a. The communication link 125-a may be an example of a 6th generation (6G), a NR or LTE link between the UE 115-a and the network entity. The communication link 125-a may include a bi-directional link that enable both uplink and downlink communications. For example, the UE 115-b may transmit uplink signals (e.g., uplink transmissions), such as uplink control signals or uplink data signals, to the network entity 105-a using the communication link 125-a and the network entity 105-a may transmit downlink signals (e.g., downlink transmissions), such as downlink control signals or downlink data signals, to the UE 115-b using the communication link 125-a.

In some examples, the network entity 105-a may transmit, to the UE, a control message 205. In some cases, the control message may be an RRC message. Additionally, or alternatively, other types of control messages may be used. The control message (e.g., RRC message) may be encoded using an ASN.1 format and packed encoding rules (PER). In some cases, the RRC message may be encoded using ASN.1 unsigned PER. In some cases, the RRC message encoded using the ASN.1 format may include redundant information that creates overhead (e.g., redundant header information, redundant data payload information, or both). For example, the RRC message may include variable size parallel lists and dependencies including a conditional presence and absence that contribute to redundancy in the ASN.1 headers. The parallel lists may include a main list and one or more extension lists, and the main list and the extension lists may include a size variable or other variables or parameters. In some cases, the size variable (or some other attribute of a list) is fixed for all members of the parallel list. But even though a same attribute is applicable to the main list and the corresponding parallel lists, the ASN.1 encoder may insert a fixed header to indicate the attribute (e.g., the size variable) for each of the members of the parallel list. In some cases, configuration parameters may be defined as conditions in field descriptions or as conditional presence statements. For example, conditions in RRC configuration if satisfied may result in a field being absent, and the absence of the field in the signaling is indicated by a presence flag being set to zero in the header, thereby resulting in overhead. The various dependencies, such as the conditional presence and absence, are neither enforced by signaling nor exploited in encoding (e.g., using existing ASN.1 encoding processes). The dependencies are captured as field description of conditional presence statements which the transmitter (e.g., a UE or a network entity) is expected, but not required by signaling design, to follow. If the receiver (e.g., a UE or a network entity) uses these statements to validate the message, and if the transmitter did not follow the conditional presence statements, the message is invalid, ignored, or discarded.

In some examples, the RRC message encoded by ASN.1 includes overhead created by the redundant size header of lists. An example parallel list is shown below.

CellsToAddModList::= SEQUENCE (SIZE (1.maxNrofCellMeas))
OF CellsToAddMod
CellsToAddModListExt-
v1710::= SEQUENCE (SIZE (1.maxNrofCellMeas)) OF
CellsToAddModExt-v1710
CellsToAddModListExt-v1800::=
SEQUENCE (SIZE (1.maxNrofCellMeas)) OF CellsToAddModExt-v1800

The lists CellsToAddModListExt-v1710 and CellsToAddModListExt-v1800, may by configuration, contain the same number of elements as in CellsToAddModList. Since the value of the constant maxNrofCellMeas is 32 (or some other fixed value), for each of the above lists, the ASN.1 encoder inserts a 5-bit fixed header overhead to indicate the actual number of elements that are included in the signaling. Even though the lists CellsToAddModListExt-v1710, CellsToAddModListExt-v1800 contain the same number of elements as in CellsToAddModList, in current ASN.1, the encoder includes the size header for each of the lists separately.

Another example of the RRC message with a parallel list is shown below.

InterFreqCarrierFreqList::=
SEQUENCE (SIZE (1.maxFreq)) OF InterFreqCarrierFreqInfo
InterFreqCarrierFreqList-v1610::=
SEQUENCE (SIZE (1.maxFreq)) OF InterFreqCarrierFreqInfo-v1610
InterFreqCarrierFreqList-v1700::=
SEQUENCE (SIZE (1.maxFreq)) OF InterFreqCarrierFreqInfo-v1700
InterFreqCarrierFreqList-v1720::=
SEQUENCE (SIZE (1.maxFreq)) OF InterFreqCarrierFreqInfo-v1720
InterFreqCarrierFreqList-v1730::=
SEQUENCE (SIZE (1.maxFreq)) OF InterFreqCarrierFreqInfo-v1730
InterFreqCarrierFreqList-v1760::=
SEQUENCE (SIZE (1.maxFreq)) OF InterFreqCarrierFreqInfo-v1760
InterFreqCarrierFreqList-v1800::=
SEQUENCE (SIZE (1.maxFreq)) OF InterFreqCarrierFreqInfo-v1800

Since the value of the constant maxFreq is 8 (or some other value), the actual size of each of the lists above are indicated by a 3-bit size indicator; however, the field description indicates that the size of all of these maxFreq parameters are the same in the RRC message. There are additional examples of parallel lists for control signaling (e.g., RRC messages) for ASN.1 formatted messages.

In some examples, the RRC message encoded by ASN.1 includes overhead created by conditional presence or absence fields. In some cases, the dependency of fields is not exploited or enforced in encoding. Different configuration parameters may be highly dependent, and the configuration parameters may be defined as conditions in a field description or as conditional presence statements. For example, conditions in the RRC control message may be “if neither dmrs-DownlinkForPDSCH-MappingTypeA-DCI-1-2 nor dmrs-DownlinkForPDSCH-MappingTypeB-DCI-1-2 is configured, the field antennaPortsFieldPresenceDCI-1-2 is absent.” In some cases, the absence of a field in signaling may be indicated by a presence flag of 0 in the header if the conditions are satisfied. The indication of the presence flag of 0 may be unnecessary when the conditions are satisfied (e.g., neither dmrs-DownlinkForPDSCH-MappingTypeA-DCI-1-2 nor dmrs-DownlinkForPDSCH-MappingTypeB-DCI-1-2 is configured) because the field (e.g., field antennaPortsFieldPresenceDCI-1-2) may not be present according to a configuration rule. Even though the configuration rule for the field description indicates that the field is absent when the conditions are satisfied, the sender (e.g., a UE or a network entity) may set the field to present and include this information as the signaling as overhead of data. Setting the field to present may be considered an error by the receiver, and the message or configuration may be ignored or discarded, potentially resulting in retransmissions, latency, additional signaling, etc. Making sure the rule is followed by signaling design (e.g., to make it impossible to include a field when the conditions for absence are satisfied) may be beneficial compared to post-fact validation of the message at the receiver based on the field description.

In some examples, techniques for reducing redundancy in control information may implement a dynamic schema to reduce signaling overhead in the ASN.1 encoded control messages. For the control message that includes parallel lists, a size parameter of a lower-level element (e.g., extension list) depends on a size parameter of a higher-level element (e.g., main list or original list). For example, the following examples of parallel lists all have a fixed max size (e.g., SIZE (maxFreq) and SIZE (maxNrofCellMeas)).

InterFreqCarrierFreqList::=
SEQUENCE (SIZE (1.maxFreq)) OF InterFreqCarrierFreqInfo
InterFreqCarrierFreqList-v1610::=
SEQUENCE (SIZE (1.maxFreq)) OF InterFreqCarrierFreqInfo-v1610
InterFreqCarrierFreqList-v1700::=
SEQUENCE (SIZE (1.maxFreq)) OF InterFreqCarrierFreqInfo-v1700
InterFreqCarrierFreqList-v1720::=
SEQUENCE (SIZE (1.maxFreq)) OF InterFreqCarrierFreqInfo-v1720
InterFreqCarrierFreqList-v1730::=
SEQUENCE (SIZE (1.maxFreq)) OF InterFreqCarrierFreqInfo-v1730
InterFreqCarrierFreqList-v1760::=
SEQUENCE (SIZE (1.maxFreq)) OF InterFreqCarrierFreqInfo-v1760
InterFreqCarrierFreqList-v1800::=
SEQUENCE (SIZE (1.maxFreq)) OF InterFreqCarrierFreqInfo-v1800
CellsToAddModList::= SEQUENCE (SIZE (1.maxNrofCellMeas))
OF CellsToAddMod
CellsToAddModListExt-
v1710::= SEQUENCE (SIZE (1.maxNrofCellMeas)) OF
CellsToAddModExt-v1710
CellsToAddModListExt-v1800::=
SEQUENCE (SIZE (1.maxNrofCellMeas)) OF CellsToAddModExt-v1800

If the size of interFreqCarrierFreqList is chosen to be 2, then all the extensions are to be fixed to size 2, and if size of CellsToAddModList is chosen to be 5, then all of the extensions are to be fixed to size 5. However, in the actual messages that are transmitted, each of the extension lists, according to the configuration rule, have encoded the respective variable length field, and at the value of the variable length field is set to 2 for the interFreqCarrierFreqList parallel lists and include exactly 2 (e.g., nothing other than 2) elements. However, signaling-wise, it may be possible to include any number of elements; and, if the network entity 105-a includes other than 2 elements, the signaling may be undefined, an error case, or a faulty configuration. In some cases, to reduce redundancy, once a main list size is chosen, the size of the dependent lists may not be encoded or indicated in the signaling. For example, if the size of InterFreqCarrierFreqList is 2, the size may not be indicated again because the later lists are also of size 2. The amount of potential faulty configurations may also be reduced if the later sizes are not encoded but implicitly derived because the network entity 105-a may not include anything other than 2 elements in later lists by the inherent signaling schema and not just based on field description understanding or configuration rules.

In some examples, techniques for reducing redundancy in control information may implement a dynamic sizing for parallel lists to reduce signaling overhead in the ASN.1 encoded control messages. For example, the network entity 105-a may generate a reduced format version of a control message comprising one or more parameters for configuring a wireless communication session, and the reduced format version may have a reduced payload compared to a non-reduced format version of the control message (e.g., reduced header size, reduced data payload size, or both). In some cases, the reduced format version may have a value of the one or more parameters absent as compared to the non-reduced format version. The network entity 105-a may encode the reduced format version of the control message. The network entity 105-a may transmit the encoded message including the reduced format version 210 of the control message to the UE 115-a. In some cases, the dynamic sizing of dependent lists or extension lists may use separate side information (e.g., information that is sent separately). The encoder or transmitter may choose the size of the parent list or main list. A separate configuration that indicates the chosen values of the lists subject to such header reduction may be provided outside of the actual message that includes the lists. In some examples, the encoder may not encode the chosen size in the message itself. The network entity 105-a may transmit, to the UE 115-a, a configuration message 215 or side information with the chosen size as a constant value for the main lists and each of the dependent lists or extension lists. In some cases, the dynamic sizing of the dependent lists or extension lists may use serial processing. For example, the encoder or transmitter may choose the size of the parent list or main list. The encoder may encode the chosen size of the main list in the message (e.g., main list is treated as of variable size). The chosen size may be a constant value for each of the dependent lists or extension lists. In some cases, the encoded message may include the reduced format version and the configuration information of the chosen size. In some cases, the serial processing case may involve the receiver decoding in real time to determine the size of the next parameter if the main list and the dependent lists are in the same message. After the UE 115-a has decoded the control message, the UE 115-a may receive, from the network entity 105-a, a message 220 based on the control message, and the UE 115-a may transmit, to the network entity 105-a, a message 225 based on the control message.

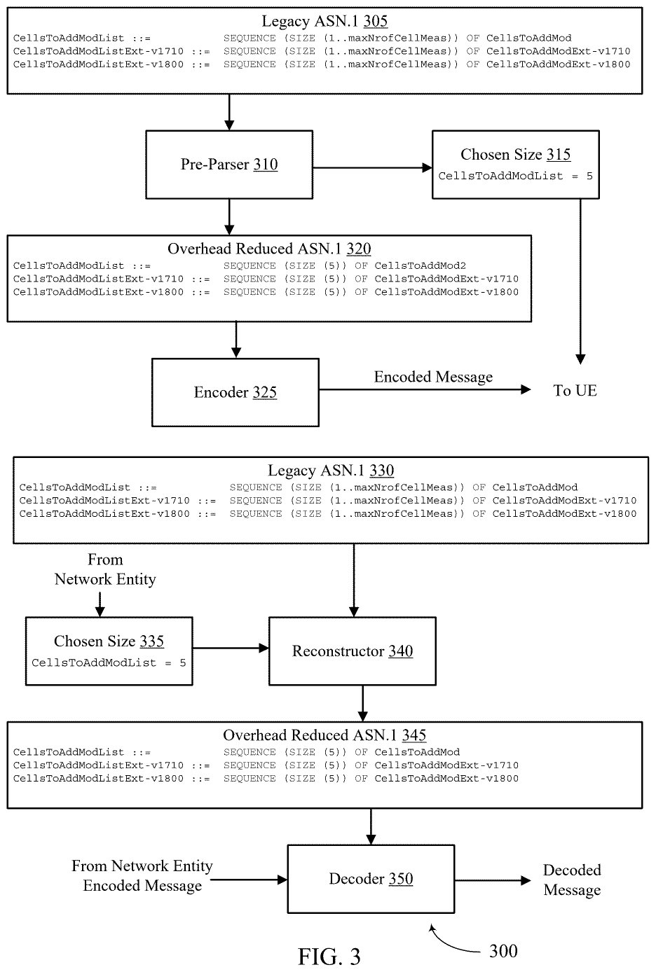

FIG. 3 shows an example of a block diagram 300 that supports techniques for reducing redundancy in control information in accordance with one or more aspects of the present disclosure. The block diagram 300 illustrates a header reduction with dynamic sizing for parallel lists. The block diagram 300 may implement or be implemented by one or more aspects described with reference to FIGS. 1 and 2. For example, the network entity 105-a may implement portions of the block diagram 300, and the UE 115-a may implement portions of the block diagram 300.

The block diagram 300 illustrates the steps for enabling dynamic sizing for parallel lists. The block diagram 300 illustrates a non-limiting example of a parallel list. The network entity 105-a may have control information in a non-reduced format version (e.g., a legacy ASN.1 format 305) of a parallel list including a main list (CellsToAddModList::=SEQUENCE (SIZE (1.maxNrofCellMeasure)) of CellstoAddMod) and a plurality of extension lists (CellsToAddModListEXt-v1740::=SEQUENCE (SIZE (1.maxNrofCellMeasure)) of CellstoAddModExt-v1710 and CellsToAddModListExt-v1800::=SEQUENCE (SIZE (1.maxNrofCellMeasure)) of CellstoAddModExt-v1800). The network entity 105-a may choose or determine the size of the concerned parent list or main list. The non-reduced version (e.g., legacy ASN.1 format 305) may be input to a pre-parser 310. In some cases, the pre-parser 310 may replace the variable SIZE in the main list as well as the dependent lists or extension lists by the chosen fixed size to generate the reduced format version or overhead reduced ASN.1 format 320. For example, the chosen size may be 5, and the main list may be CellsToAddModList::=SEQUENCE (SIZE (5)) of CellstoAddMod) and the extension lists may be (CellsToAddModListEXt-v1740::=SEQUENCE (SIZE (5)) of CellstoAddModExt-v1710 and CellsToAddModListExt-v1800::=SEQUENCE (SIZE (5)) of CellstoAddModExt-v1800). The 5-bit header for each list may be reduced for the reduced format version. In some cases, the pre-parser 310 may replace the variable SIZE in the dependent lists or extension lists by the chosen fixed size. The reduced format version may be encoded by the encoder 325. The network entity 105-a may transmit the encoded stream (e.g., encoded message including the reduced format version) to the receiver (e.g., UE 115-a). In some cases, the network entity 105-a may transmit the side information of the chosen size 315 to the UE 115-a. In some cases, the side information or configuration message may be in an encoding control notation (ECN) format or an ASN.1 format. In some cases, the encoded message may include the reduced format version and the side information of the chosen size.

The UE 115-a may receive, from the network entity 105-a, the encoded stream or encoded message according to the reduced format version or overhead reduced ASN.1 that has a reduced payload compared to the non-reduced format version (e.g., legacy ASN.1 format 305). The UE 115-a may be configured with a legacy ASN.1 format 330 or full ASN.1 definition corresponding to the encoded overhead reduced ASN.1 format 320. For example, the legacy ASN.1 format configured at the UE 115-a may be the same as the legacy ASN.1 format 305 at the network entity 105-b.

A pre-parser 340 may generate an overhead reduced ASN.1 format 345 on the receiver side (e.g., UE 115-a) using the full ASN.1 definition (e.g., legacy ASN.1 format 330) as well as the control information (e.g., a value of a chosen size 335) that may be sent by the transmitter (e.g., network entity 105-a). The overhead reduced ASN.1 format 345 generated at the receiver is the same as the overhead reduced ASN.1 format 330 generated at the transmitter. The receiver then may decode (e.g., decoder 350) the received encoded message encoded according to the reduced format version or overhead reduced ASN.1 format 345.

For the example with the separate side information (e.g., chosen size 335), the separate configuration that indicates the chosen values of the lists subject to such header reduction may be provided outside of the actual message that includes the lists. The pre-parser 340 may use the separate side information or separate configuration (e.g., chosen size 335) to replace the variable size in the concerned lists with a constant size as part of generating the reduced format version before decoding (e.g., reverse process of encoding by the network entity 105-a). The separate side information may be provided via ECN as information in outside wrappers. For example, the UE 115-a may receive the encoded stream (e.g., the overhead reduced ASN.1 format 330), and the UE 115-a may receive the separate configuration (e.g., chosen size 335). The UE 115-a may replace the variable SIZE in the main list as well as the dependent lists by the fixed chosen size (e.g., chosen size 335). The UE 115-a may use the received payload based on the replaced variable SIZE in the main list and the dependent lists as the ASN.1 schema for decoding, and the UE 115-a may decode the full payload of the control message.

For the example without the separate side information or the serial processing example, the UE 115-a or receiver may determine the SIZE of the earlier list (e.g., main list) by the time the dependent lists or extension lists are generated or parsed. For example, the UE 115-a may determine the value of the parameter or variable (e.g., SIZE) based on the value of the parameter included in the main list. The pre-parser 340 may use the value of the parameter to replace the variable size in the concerned lists with a constant size as part of as part of generating the reduced format version before decoding (e.g., reverse process of encoding by the network entity 105-a). For example, the UE 115-a may receive the encoded stream (e.g., the encoded overhead reduced ASN.1 format 330). The UE 115-a may replace the variable SIZE in the dependent lists by the chosen size in the main list. The UE 115-a may use the received payload based on the replaced variable SIZE the dependent lists as the ASN.1 schema for decoding, and the UE 115-a may decode the full payload of the control message.

In some examples, techniques for reducing redundancy in control information may implement header reduction with dynamic sizing for concatenated lists. The solutions described herein for parallel lists may be used for other cases, such as concatenated lists. If the extension list (Ext list) to an original list is to be concatenated, the future extensions of the concatenated lists may not encode the size(s). For example, the network entity 105-a may pre-parse or generate the reduced format version that comprises an original list and one or more concatenated extension lists. The value of the one or more parameters that indicate a quantity of elements in the original list and in each of the plurality of extension lists (e.g., the chosen size) may be absent for the original list and for each of the concatenated extension lists with the value being provided as side information or a side configuration. The UE 115-a may generate the reduced format version based on the original list and the concatenated extension lists using the side information indicating the value of the one or more parameters. In some cases, the network entity 105-a may pre-parse or generate the reduced format version that comprises an original list and one or more concatenated extension lists. The value of the one or more parameters that indicate a quantity of elements in the original list and in each of the plurality of extension lists (e.g., the chosen size) may be present in the original list and may be absent for each of the concatenated extension lists. The UE 115-a may generate the reduced format version based on the original list and the concatenated extension lists using the value of the one or more parameters.

In some examples, techniques for reducing redundancy in control information may implement dependency, conditional presence or absence reduction. In RRC messages, configuration parameters may be dependent on other parameters or conditions. The different configuration parameters may be defined as conditions in a field description or as conditional presence statements. For example, a conditional rule for configuration a message may be phrased as “if neither dmrs-DownlinkForPDSCH-MappingTypeA-DCI-1-2 nor dmrs-DownlinkForPDSCH-MappingTypeB-DCI-1-2 is configured, the field antennaPortsFieldPresenceDCI-1-2 is absent.” The network entity 105-a (e.g., the pre-parser 310 of the network entity) may create the ASN.1 schema for encoding based on the conditions to be fulfilled. For example, instead of indicating the absence of a field in the signaling by including the presence flag=0 in the header if the conditions are satisfied, the network entity may remove the field when the conditions are satisfied (e.g., neither dmrs-DownlinkForPDSCH-MappingTypeA-DCI-1-2 nor dmrs-DownlinkForPDSCH-MappingTypeB-DCI-1-2 is configured). The field may be removed from the ASN.1 schema by the pre-parser so the field may not be present. The removal of the field may ensure that the configuration rule is followed by signaling design (e.g., the field may not be included when the conditions for absence are satisfied).

In some examples, techniques for reducing redundancy in control information may avoid redundancy with dynamic ASN.1 schema. The techniques may enable the removal of redundant headers in the ASN.1 encoded message. In one example, the transmitter may remove redundancy by avoiding encoding the size of each list in the header by pre-processing the ASN.1. In another example, the transmitter may remove redundancy by avoiding encoding the presence or absence of dependent parameters by pre-processing the ASN.1 schema. The techniques for reducing redundancy in control information ensure that the signaled messages conforms to the conditional presence or absence and other criteria such as the size of the list at the encoder schema level instead of being based on field description validation. The pre-parsing of the ASN.1 schema may eliminate the redundant header information on the transmitter side. In some cases, the transmitter may transmit the side information to the receiver. For example, the transmitter may transmit, to the receiver, the side information separate from the reduced format version of the control message, such as the ECN format. In some cases, the transmitter may encode in the reduced format version of the control message the side information (e.g., include the side information for the main occurrence and remove redundancy in later dependent parameters or list occurrences). The receiver may generate the reduced format ASN.1 scheme using the side information before performing the decoding operation.

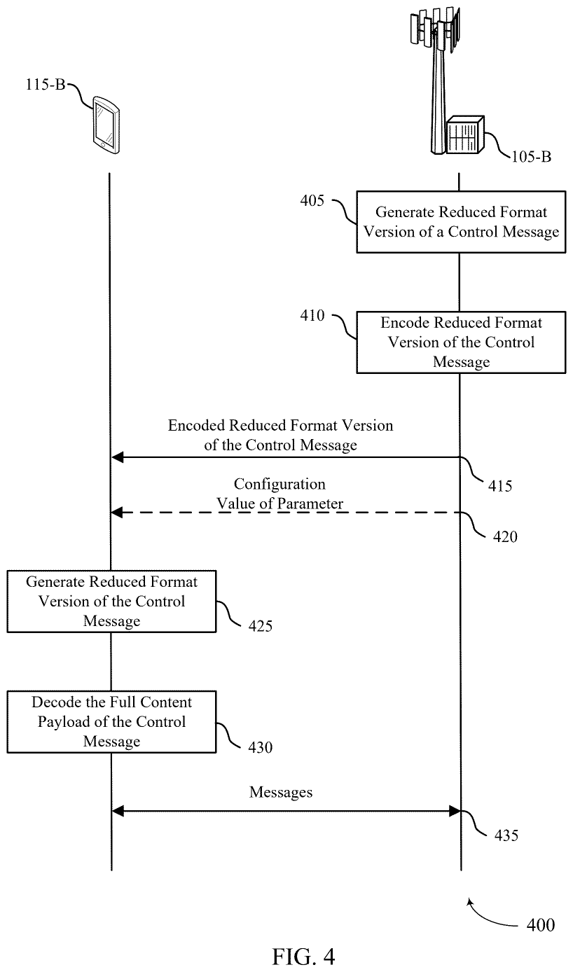

FIG. 4 shows an example of a process flow 400 that supports techniques for reducing redundancy in control information in accordance with one or more aspects of the present disclosure. The process flow 400 may implement or may be implemented by aspects of the wireless communications system 100 and the wireless communications system 200. For example, the process flow 400 may include a UE 115-b and a network entity 105-b which may be examples of corresponding devices and entities as described with reference to FIGS. 1 and 2. In the following description of the process flow 400, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 400, and other operations may be added to the process flow 400.

At 405, the network entity 105-b may generate a reduced format version of a control message including one or more parameters for configuring a wireless communication session. The reduced format version may have a reduced payload compared to a non-reduced format version of the control message. The reduced format version may have a value of the one or more parameters absent as compared to the non-reduced format version. In some cases, the network entity 105-a may remove a conditional presence indicator from a header of the control message based on a condition being satisfied, and the condition specifies, based on a configuration, that a field is absent for a transmission of the control message.

At 410, the network entity 105-b may encode the reduced format version of the control message.

At 415, the UE 115-b may receive, from the network entity 105-b, the encoded message including the reduced format version of the control message including the one or more parameters for configuring a wireless communication session. The reduced format version may have a reduced payload compared to a non-reduced format version of the control message. In some cases, the reduced format version may be an ASN.1 format. In some cases, the reduced payload may include a reduced header size compared to the non-reduced format version of the control message.

In some examples, the reduced format version of the control message may include a main list and a plurality of extension lists, and the value of the one or more parameters may indicate a quantity of elements in the main list and in each of the plurality of extension lists. The value of the one or more parameters may be absent for the main list and for each of the plurality of extension lists. In some cases, the value of the one or more parameters may be present for the main list and the value of the one or more parameters may be absent for each of the plurality of extension lists.

In some cases, the reduced format version may include an original list and one or more concatenated extension lists. The value of the one or more parameters may indicate a quantity of elements in the original list and in each of the plurality of concatenated extension lists. In some cases, the value of the one or more parameters may be absent for the original list and for the one or more concatenated extension lists. In some cases, the value of the one or more parameters may be absent for the one or more concatenated extension lists.

At 420, the UE 115-b may receive, from the network entity 105-b, a message indicating a configuration that indicates the value of the one or more parameters. In some cases, the UE 115-a may receive side information indicating the value of the one or more parameters. The side information may be in an ECN format or ASN.1 format

At 425, the UE 115-a may generate a reduced format version based on the non-reduced format version and the value of the one or more parameters. The generated reduced format version at the UE 115-b is the same as the reduced format version generated at the network entity 105-b. In some cases, the UE 115-a may generate the reduced format version based on generating the main list and each of the plurality of extension lists using the value of the one or more parameters. In some cases, the UE 115-a may generate the reduced format version based on generating each of the plurality of extension lists using the value of the one or more parameters. In some cases, the UE 115-a may generate the reduced format version based on generating the original list and each of the concatenated of extension lists using the value of the one or more parameters. In some cases, the UE 115-a may generate the reduced format version based on generating each of the concatenated lists using the value of the one or more parameters.

At 430, the UE 115-a may decode a full payload of the control message based on the generated reduced format version.

At 435, the UE 115-a may communicate, with the network entity 105-b, one or more messages based on the full payload of the control message.

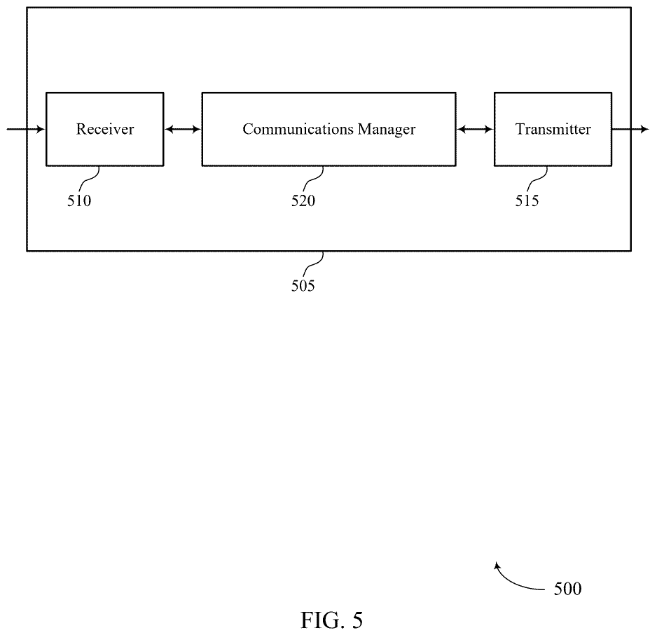

FIG. 5 shows a block diagram 500 of a device 505 that supports techniques for reducing redundancy in control information in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for reducing redundancy in control information). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for reducing redundancy in control information). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for reducing redundancy in control information as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving a reduced format version of a control message including one or more parameters for configuring a wireless communication session, where the reduced format version has a reduced payload compared to a non-reduced format version of the control message. The communications manager 520 is capable of, configured to, or operable to support a means for reconstructing a full payload of the control message based on the reduced format version and a value of the one or more parameters. The communications manager 520 is capable of, configured to, or operable to support a means for decoding the full payload of the control message. The communications manager 520 is capable of, configured to, or operable to support a means for communicating one or more messages based on the full payload of the control message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources.

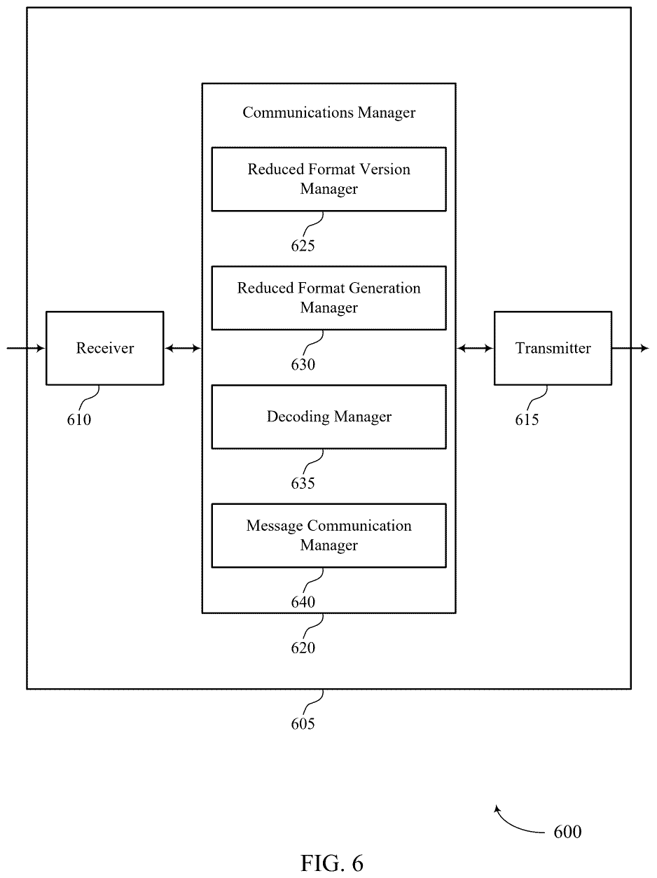

FIG. 6 shows a block diagram 600 of a device 605 that supports techniques for reducing redundancy in control information in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for reducing redundancy in control information). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for reducing redundancy in control information). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for reducing redundancy in control information as described herein. For example, the communications manager 620 may include a reduced format version manager 625, a reduced format generation manager 630, a decoding manager 635, a message communication manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The reduced format version manager 625 is capable of, configured to, or operable to support a means for receiving an encoded message including a reduced format version of a control message including one or more parameters for configuring a wireless communication session, where the reduced format version has a reduced payload compared to a non-reduced format version of the control message. The reduced format generation manager 630 is capable of, configured to, or operable to support a means for generating a second reduced format version based on the non-reduced format version and a value of the one or more parameters. The decoding manager 635 is capable of, configured to, or operable to support a means for decoding a full payload of the control message based on the second reduced format version. The message communication manager 640 is capable of, configured to, or operable to support a means for communicating one or more messages based on the full payload of the control message.

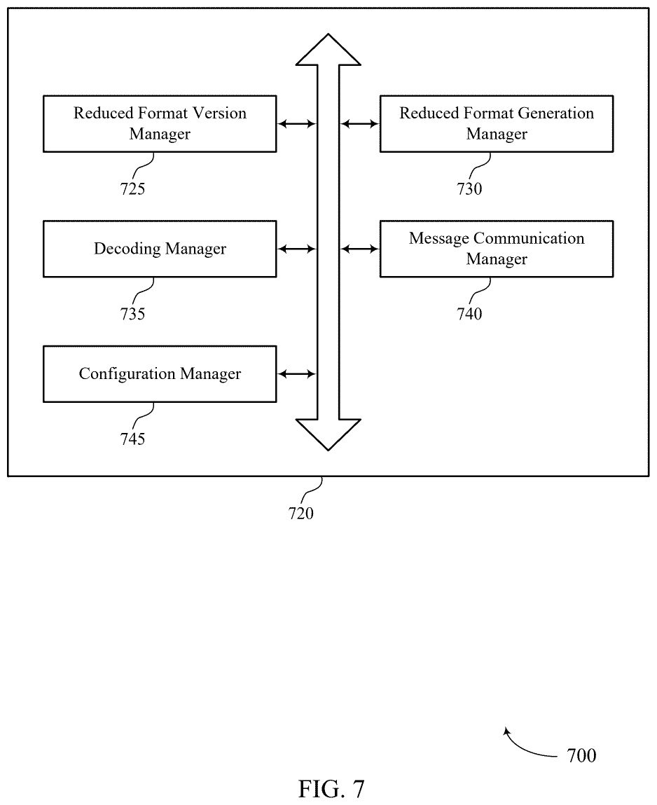

FIG. 7 shows a block diagram 700 of a communications manager 720 that supports techniques for reducing redundancy in control information in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for reducing redundancy in control information as described herein. For example, the communications manager 720 may include a reduced format version manager 725, a reduced format generation manager 730, a decoding manager 735, a message communication manager 740, a configuration manager 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The reduced format version manager 725 is capable of, configured to, or operable to support a means for receiving an encoded message including a reduced format version of a control message including one or more parameters for configuring a wireless communication session, where the reduced format version has a reduced payload compared to a non-reduced format version of the control message. The reduced format generation manager 730 is capable of, configured to, or operable to support a means for generating a second reduced format version based on the non-reduced format version and a value of the one or more parameters. The decoding manager 735 is capable of, configured to, or operable to support a means for decoding a full payload of the control message based on the second reduced format version. The message communication manager 740 is capable of, configured to, or operable to support a means for communicating one or more messages based on the full payload of the control message.

In some examples, to support receiving the first reduced format version, the reduced format version manager 725 is capable of, configured to, or operable to support a means for receiving the first reduced format version that includes a main list and a set of multiple extension lists, where the value of the one or more parameters indicates a quantity of elements in the main list and in each of the set of multiple extension lists, and where the value of the one or more parameters is absent for the main list and for each of the set of multiple extension lists.

In some examples, the configuration manager 745 is capable of, configured to, or operable to support a means for receiving, prior to generating the second reduced format version, a message indicating a configuration that indicates the value of the one or more parameters.

In some examples, to support generating the second reduced format version, the reduced format generation manager 730 is capable of, configured to, or operable to support a means for generating the second reduced format version based on generating the main list and each of the set of multiple extension lists using the value of the one or more parameters.

In some examples, to support receiving the first reduced format version, the reduced format version manager 725 is capable of, configured to, or operable to support a means for receiving the first reduced format version that includes a main list and a set of multiple extension lists, where the value of the one or more parameters indicates a quantity of elements in the main list and in each of the set of multiple extension lists, and where the value of the one or more parameters is present for the main list and the value of the one or more parameters is absent for each of the set of multiple extension lists.

In some examples, to support generating the second reduced format version, the reduced format generation manager 730 is capable of, configured to, or operable to support a means for generating the second reduced format version based on generating each of the set of multiple extension lists using the value of the one or more parameters.

In some examples, to support receiving the first reduced format version, the reduced format version manager 725 is capable of, configured to, or operable to support a means for receiving the first reduced format version that includes an original list and one or more concatenated extension lists, where the value of the one or more parameters indicates a quantity of elements in the original list and in each of the set of multiple concatenated extension lists, and where the value of the one or more parameters is absent for the original list and for the one or more concatenated extension lists.

In some examples, the configuration manager 745 is capable of, configured to, or operable to support a means for receiving, prior to generating the second reduced format version, a message indicating a configuration that indicates the value of the one or more parameters, and where generating the second reduced format version further includes, generating the second reduced format version based on generating the original list and each of the one or more concatenated extension lists using the value of the one or more parameters. In some examples, to support generating the second reduced format version, the reduced format generation manager 730 is capable of, configured to, or operable to support a means for generating the second reduced format version based on generating the original list and each of the one or more concatenated extension lists using the value of the one or more parameters.

In some examples, to support receiving the first reduced format version, the reduced format version manager 725 is capable of, configured to, or operable to support a means for receiving the first reduced format version that includes an original list and one or more concatenated extension lists, where the value of the one or more parameters indicates a quantity of elements in the original list and in each of the set of multiple concatenated extension lists, and where the value of the one or more parameters is absent for the one or more concatenated extension lists, where generating the second reduced format version further includes, generating the second reduced format version based on generating each of the one or more concatenated extension lists using the value of the one or more parameters. In some examples, to support generating the second reduced format version, the reduced format generation manager 730 is capable of, configured to, or operable to support a means for generating the second reduced format version based on generating each of the one or more concatenated extension lists using the value of the one or more parameters.

In some examples, the first reduced format version includes an abstract syntax notation one format.

In some examples, the reduced payload includes a reduced header size compared to the non-reduced format version of the control message.

In some examples, the configuration manager 745 is capable of, configured to, or operable to support a means for receiving, prior to communicating the one or more messages, side information indicating the value of the one or more parameters.

In some examples, the side information includes an encoding control notation format or an abstract syntax notation one format.

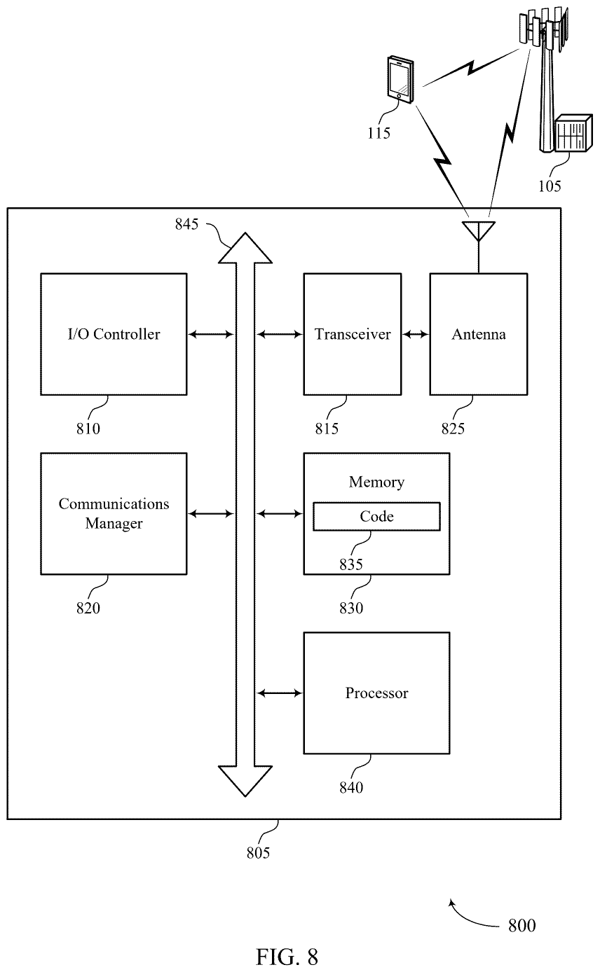

FIG. 8 shows a diagram of a system 800 including a device 805 that supports techniques for reducing redundancy in control information in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for reducing redundancy in control information). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving a reduced format version of a control message including one or more parameters for configuring a wireless communication session, where the reduced format version has a reduced payload compared to a non-reduced format version of the control message. The communications manager 820 is capable of, configured to, or operable to support a means for reconstructing a full payload of the control message based on the reduced format version and a value of the one or more parameters. The communications manager 820 is capable of, configured to, or operable to support a means for decoding the full payload of the control message. The communications manager 820 is capable of, configured to, or operable to support a means for communicating one or more messages based on the full payload of the control message.

By including or configuring the communications manager 820 in accordance with examples as described herein, the device 805 may support techniques for improved communication reliability, reduced latency, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for reducing redundancy in control information as described herein, or the at least one processor 840 and the at least one memory 830 may be otherwise configured to, individually or collectively, perform or support such operations.

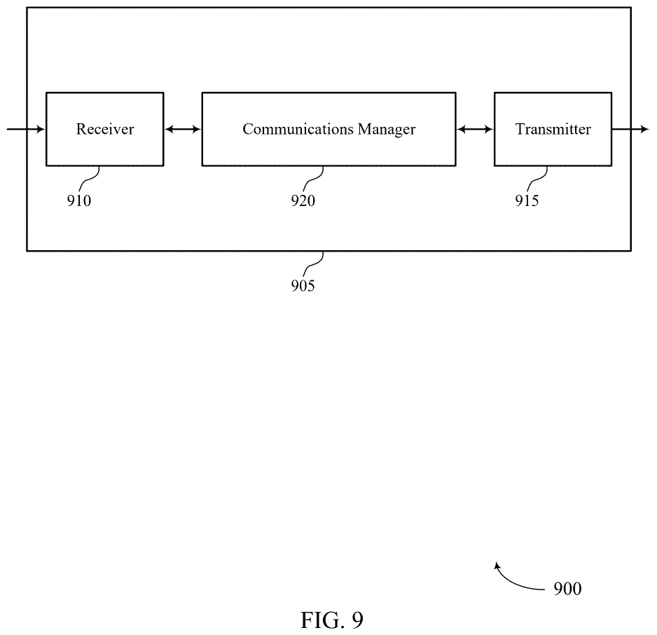

FIG. 9 shows a block diagram 900 of a device 905 that supports techniques for reducing redundancy in control information in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for reducing redundancy in control information as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for generating a reduced format version of a control message including one or more parameters for configuring a wireless communication session, where the reduced format version has a reduced payload compared to a non-reduced format version of the control message, where the reduced format version has a value of the one or more parameters absent as compared to the non-reduced format version. The communications manager 920 is capable of, configured to, or operable to support a means for encoding the reduced format version of the control message. The communications manager 920 is capable of, configured to, or operable to support a means for outputting the encoded reduced format version of the control message.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for more efficient utilization of communication resources.

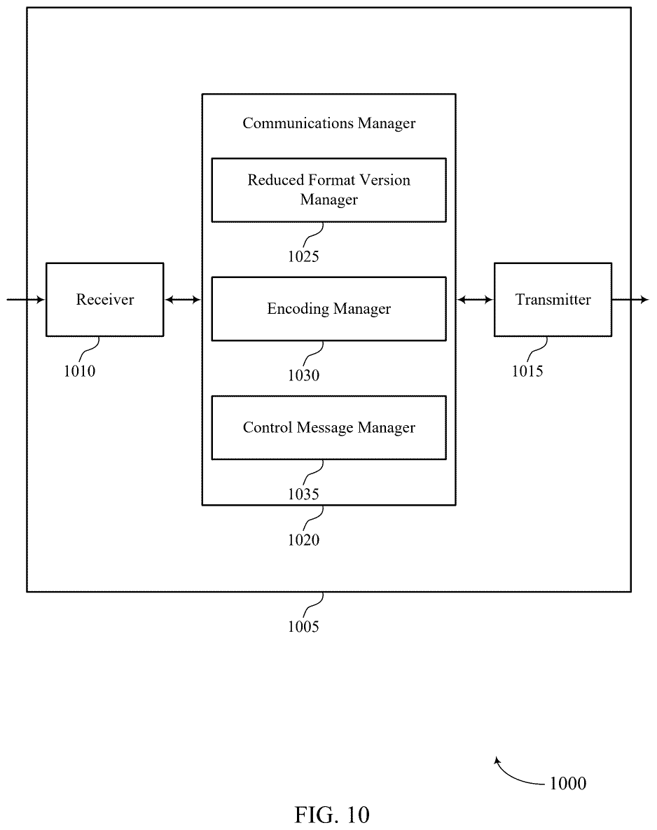

FIG. 10 shows a block diagram 1000 of a device 1005 that supports techniques for reducing redundancy in control information in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for reducing redundancy in control information as described herein. For example, the communications manager 1020 may include a reduced format version manager 1025, an encoding manager 1030, a control message manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The reduced format version manager 1025 is capable of, configured to, or operable to support a means for generating a reduced format version of a control message including one or more parameters for configuring a wireless communication session, where the reduced format version has a reduced payload compared to a non-reduced format version of the control message, where the reduced format version has a value of the one or more parameters absent as compared to the non-reduced format version. The encoding manager 1030 is capable of, configured to, or operable to support a means for encoding the reduced format version of the control message. The control message manager 1035 is capable of, configured to, or operable to support a means for outputting the encoded reduced format version of the control message.

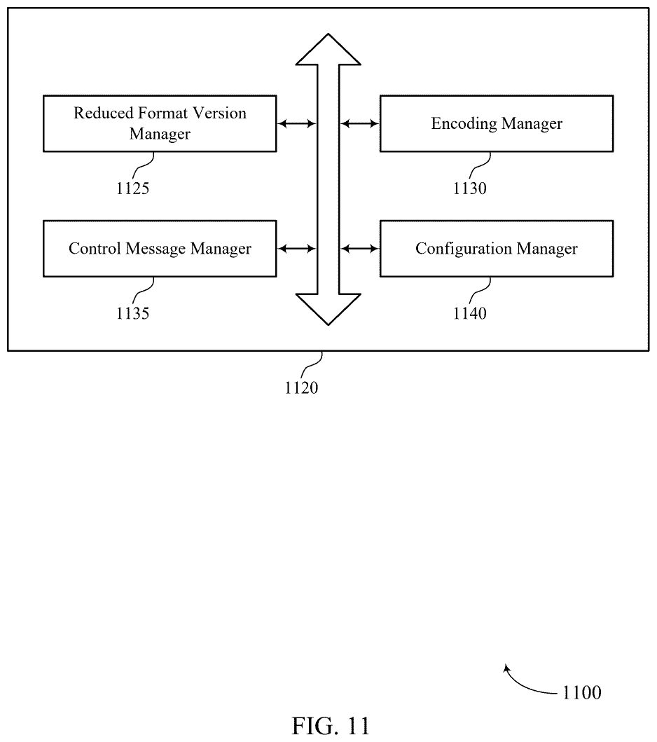

FIG. 11 shows a block diagram 1100 of a communications manager 1120 that supports techniques for reducing redundancy in control information in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for reducing redundancy in control information as described herein. For example, the communications manager 1120 may include a reduced format version manager 1125, an encoding manager 1130, a control message manager 1135, a configuration manager 1140, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The reduced format version manager 1125 is capable of, configured to, or operable to support a means for generating a reduced format version of a control message including one or more parameters for configuring a wireless communication session, where the reduced format version has a reduced payload compared to a non-reduced format version of the control message, where the reduced format version has a value of the one or more parameters absent as compared to the non-reduced format version. The encoding manager 1130 is capable of, configured to, or operable to support a means for encoding the reduced format version of the control message. The control message manager 1135 is capable of, configured to, or operable to support a means for outputting the encoded reduced format version of the control message.

In some examples, to support generating the reduced format version, the reduced format version manager 1125 is capable of, configured to, or operable to support a means for generating the reduced format version that includes a main list and a set of multiple extension lists, where the value of the one or more parameters indicates a quantity of elements in the main list and in each of the set of multiple extension lists, and where the value of the one or more parameters is absent for the main list and for each of the set of multiple extension lists.

In some examples, the configuration manager 1140 is capable of, configured to, or operable to support a means for outputting, prior to outputting the encoded reduced format version, a message indicating a configuration that indicates the value of the one or more parameters.

In some examples, to support generating the reduced format version, the reduced format version manager 1125 is capable of, configured to, or operable to support a means for generating the reduced format version that includes a main list and a set of multiple extension lists, where the value of the one or more parameters indicates a quantity of elements in the main list and in each of the set of multiple extension lists, and where the value of the one or more parameters is present for the main list and the value of the one or more parameters is absent for each of the set of multiple extension lists.

In some examples, to support generating the reduced format version, the reduced format version manager 1125 is capable of, configured to, or operable to support a means for removing a conditional presence indicator from a header of the control message based on a condition being satisfied, where the condition specifies, based on a configuration, that a field is absent for a transmission of the control message.

In some examples, the reduced format version includes an abstract syntax notation one format.

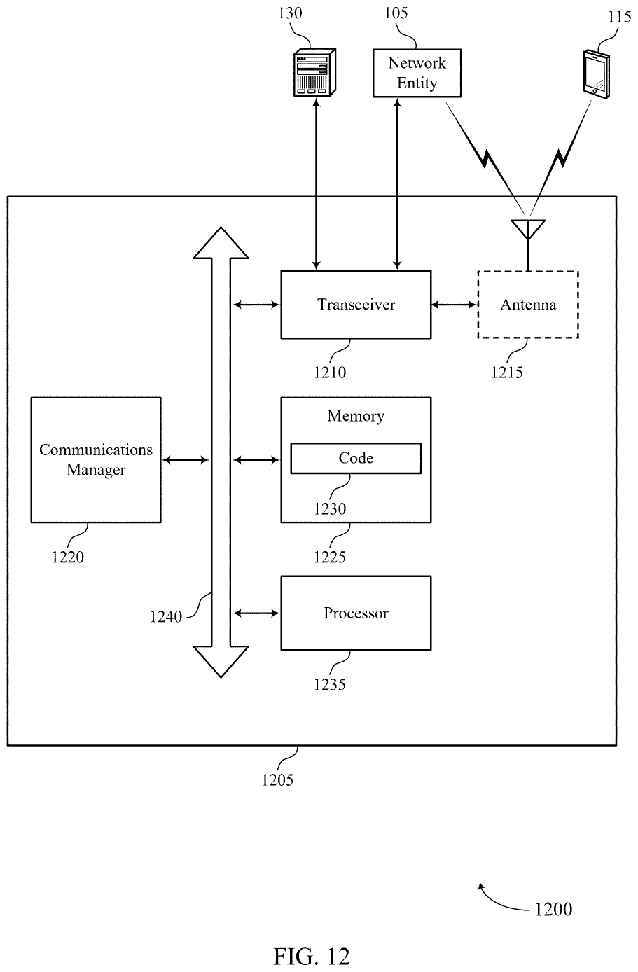

FIG. 12 shows a diagram of a system 1200 including a device 1205 that supports techniques for reducing redundancy in control information in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for reducing redundancy in control information). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for generating a reduced format version of a control message including one or more parameters for configuring a wireless communication session, where the reduced format version has a reduced payload compared to a non-reduced format version of the control message, where the reduced format version has a value of the one or more parameters absent as compared to the non-reduced format version. The communications manager 1220 is capable of, configured to, or operable to support a means for encoding the reduced format version of the control message. The communications manager 1220 is capable of, configured to, or operable to support a means for outputting the encoded reduced format version of the control message.

By including or configuring the communications manager 1220 in accordance with examples as described herein, the device 1205 may support techniques for improved communication reliability, reduced latency, more efficient utilization of communication resources, and improved coordination between devices.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for reducing redundancy in control information as described herein, or the at least one processor 1235 and the at least one memory 1225 may be otherwise configured to, individually or collectively, perform or support such operations.

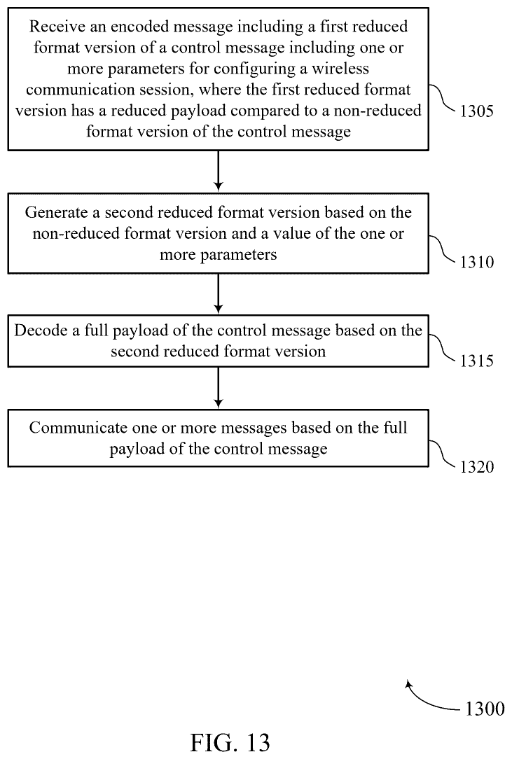

FIG. 13 shows a flowchart illustrating a method 1300 that supports techniques for reducing redundancy in control information in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving an encoded message including a first reduced format version of a control message including one or more parameters for configuring a wireless communication session, where the first reduced format version has a reduced payload compared to a non-reduced format version of the control message. The operations of 1305 may be performed in accordance with examples as disclosed herein. In some examples, aspects of the operations of 1305 may be performed by a reduced format version manager 725 as described with reference to FIG. 7.

At 1310, the method may include generating a second reduced format version based on the non-reduced format version and a value of the one or more parameters. The second reduced format version has the reduced payload compared to the non-reduced format version. The operations of 1310 may be performed in accordance with examples as disclosed herein. In some examples, aspects of the operations of 1310 may be performed by a reduced format generation manager 730 as described with reference to FIG. 7.

At 1315, the method may include decoding a full payload of the control message based on the second reduced format version. The operations of 1315 may be performed in accordance with examples as disclosed herein. In some examples, aspects of the operations of 1315 may be performed by a decoding manager 735 as described with reference to FIG. 7.

At 1320, the method may include communicating one or more messages based on the full payload of the control message. The operations of 1320 may be performed in accordance with examples as disclosed herein. In some examples, aspects of the operations of 1320 may be performed by a message communication manager 740 as described with reference to FIG. 7.

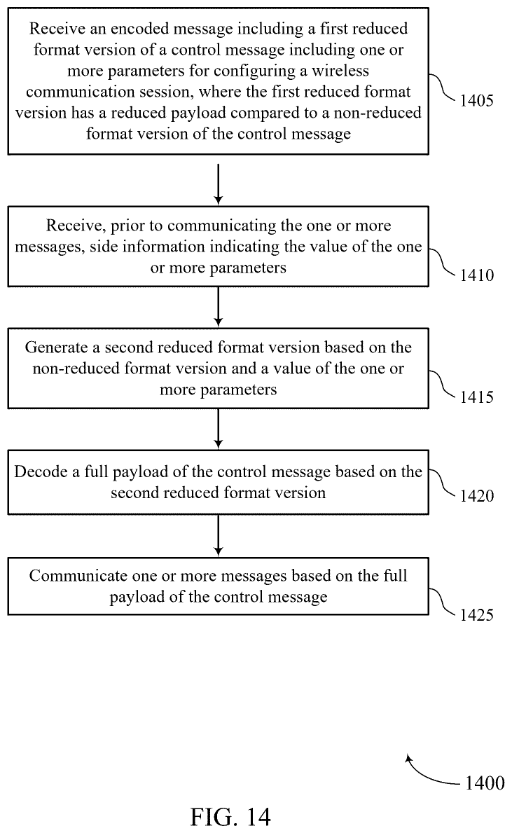

FIG. 14 shows a flowchart illustrating a method 1400 that supports techniques for reducing redundancy in control information in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving an encoded message including a first reduced format version of a control message including one or more parameters for configuring a wireless communication session, where the first reduced format version has a reduced payload compared to a non-reduced format version of the control message. The operations of 1405 may be performed in accordance with examples as disclosed herein. In some examples, aspects of the operations of 1405 may be performed by a reduced format version manager 725 as described with reference to FIG. 7.

At 1410, the method may include receiving, prior to communicating the one or more messages, side information indicating the value of the one or more parameters. The operations of 1410 may be performed in accordance with examples as disclosed herein. In some examples, aspects of the operations of 1410 may be performed by a configuration manager 745 as described with reference to FIG. 7.

At 1415, the method may include generating a second reduced format version based on the non-reduced format version and a value of the one or more parameters. The operations of 1415 may be performed in accordance with examples as disclosed herein. In some examples, aspects of the operations of 1415 may be performed by a reduced format generation manager 730 as described with reference to FIG. 7.

At 1420, the method may include decoding a full payload of the control message based on the second reduced format version. The operations of 1420 may be performed in accordance with examples as disclosed herein. In some examples, aspects of the operations of 1420 may be performed by a decoding manager 735 as described with reference to FIG. 7.

At 1425, the method may include communicating one or more messages based on the full payload of the control message. The operations of 1425 may be performed in accordance with examples as disclosed herein. In some examples, aspects of the operations of 1425 may be performed by a message communication manager 740 as described with reference to FIG. 7.

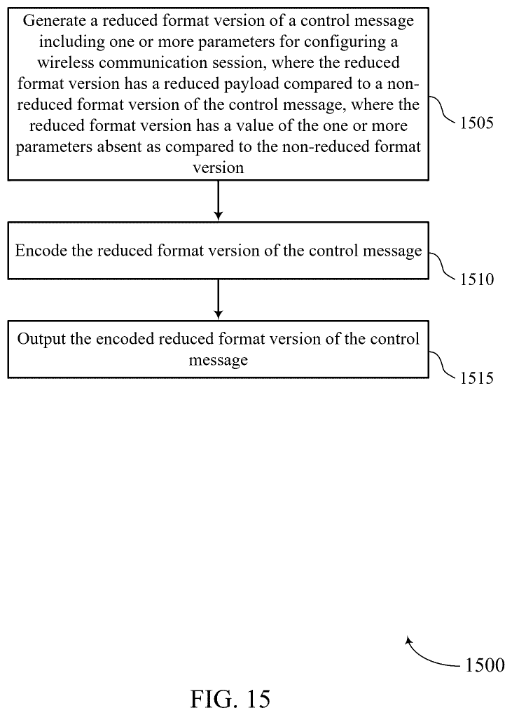

FIG. 15 shows a flowchart illustrating a method 1500 that supports techniques for reducing redundancy in control information in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include generating a reduced format version of a control message including one or more parameters for configuring a wireless communication session, where the reduced format version has a reduced payload compared to a non-reduced format version of the control message, where the reduced format version has a value of the one or more parameters absent as compared to the non-reduced format version. The operations of 1505 may be performed in accordance with examples as disclosed herein. In some examples, aspects of the operations of 1505 may be performed by a reduced format version manager 1125 as described with reference to FIG. 11.

At 1510, the method may include encoding the reduced format version of the control message. The operations of 1510 may be performed in accordance with examples as disclosed herein. In some examples, aspects of the operations of 1510 may be performed by an encoding manager 1130 as described with reference to FIG. 11.

At 1515, the method may include outputting the encoded reduced format version of the control message. The operations of 1515 may be performed in accordance with examples as disclosed herein. In some examples, aspects of the operations of 1515 may be performed by a control message manager 1135 as described with reference to FIG. 11.

The following provides an overview of aspects of the present disclosure:

Aspect 1: A method for wireless communications by a UE, comprising: receiving an encoded message comprising a first reduced format version of a control message comprising one or more parameters for configuring a wireless communication session, wherein the first reduced format version has a reduced payload compared to a non-reduced format version of the control message; generating a second reduced format version based at least in part on the non-reduced format version and a value of the one or more parameters, wherein the second reduced format version has the reduced payload compared to the non-reduced format version; decoding a full payload of the control message based at least in part on the second reduced format version; and communicating one or more messages based at least in part on the full payload of the control message.

Aspect 2: The method of aspect 1, wherein receiving the first reduced format version further comprises: receiving the first reduced format version that comprises a main list and a plurality of extension lists, wherein the value of the one or more parameters indicates a quantity of elements in the main list and in each of the plurality of extension lists, and wherein the value of the one or more parameters is absent for the main list and for each of the plurality of extension lists.

Aspect 3: The method of aspect 2, further comprising: receiving, prior to generating the second reduced format version, a message indicating a configuration that indicates the value of the one or more parameters.

Aspect 4: The method of aspect 3, wherein generating the second reduced format version further comprises: generating the second reduced format version based at least in part on generating the main list and each of the plurality of extension lists using the value of the one or more parameters.

Aspect 5: The method of aspect 1, wherein receiving the first reduced format version further comprises: receiving the first reduced format version that comprises a main list and a plurality of extension lists, wherein the value of the one or more parameters indicates a quantity of elements in the main list and in each of the plurality of extension lists, and wherein the value of the one or more parameters is present for the main list and the value of the one or more parameters is absent for each of the plurality of extension lists.

Aspect 6: The method of aspect 5, wherein generating the second reduced format version further comprises: generating the second reduced format version based at least in part on generating each of the plurality of extension lists using the value of the one or more parameters.

Aspect 7: The method of aspect 1, wherein receiving the first reduced format version further comprises: receiving the first reduced format version that comprises an original list and one or more concatenated extension lists, wherein the value of the one or more parameters indicates a quantity of elements in the original list and in each of the plurality of concatenated extension lists, and wherein the value of the one or more parameters is absent for the original list and for the one or more concatenated extension lists.

Aspect 8: The method of aspect 7, further comprises: receiving, prior to generating the second reduced format version, a message indicating a configuration that indicates the value of the one or more parameters, and wherein generating the second reduced format version further comprises: generating the second reduced format version based at least in part on generating the original list and each of the one or more concatenated extension lists using the value of the one or more parameters.

Aspect 9: The method of aspect 1, wherein receiving the first reduced format version further comprises: receiving the first reduced format version that comprises an original list and one or more concatenated extension lists, wherein the value of the one or more parameters indicates a quantity of elements in the original list and in each of the plurality of concatenated extension lists, and wherein the value of the one or more parameters is absent for the one or more concatenated extension lists, wherein generating the second reduced format version further comprises: generating the second reduced format version based at least in part on generating each of the one or more concatenated extension lists using the value of the one or more parameters.

Aspect 10: The method of any of aspects 1 through 9, wherein the first reduced format version comprises an ASN.1 format.

Aspect 11: The method of any of aspects 1 through 10, wherein the reduced payload comprises a reduced header size compared to the non-reduced format version of the control message.

Aspect 12: The method of aspect 1, further comprising: receiving, prior to communicating the one or more messages, side information indicating the value of the one or more parameters.

Aspect 13: The method of aspect 12, wherein the side information comprises an ECN format or an ASN.1 format.

Aspect 14: A method for wireless communications by a network entity, comprising: generating a reduced format version of a control message comprising one or more parameters for configuring a wireless communication session, wherein the reduced format version has a reduced payload compared to a non-reduced format version of the control message, wherein the reduced format version has a value of the one or more parameters absent as compared to the non-reduced format version; encoding the reduced format version of the control message; and outputting the encoded reduced format version of the control message.

Aspect 15: The method of aspect 14, wherein generating the reduced format version further comprises: generating the reduced format version that comprises a main list and a plurality of extension lists, wherein the value of the one or more parameters indicates a quantity of elements in the main list and in each of the plurality of extension lists, and wherein the value of the one or more parameters is absent for the main list and for each of the plurality of extension lists.

Aspect 16: The method of aspect 15, further comprising: outputting, prior to outputting the encoded reduced format version, a message indicating a configuration that indicates the value of the one or more parameters.

Aspect 17: The method of aspect 14, wherein generating the reduced format version further comprises: generating the reduced format version that comprises a main list and a plurality of extension lists, wherein the value of the one or more parameters indicates a quantity of elements in the main list and in each of the plurality of extension lists, and wherein the value of the one or more parameters is present for the main list and the value of the one or more parameters is absent for each of the plurality of extension lists.

Aspect 18: The method of aspect 14, wherein generating the reduced format version further comprises: removing a conditional presence indicator from a header of the control message based at least in part on a condition being satisfied, wherein the condition specifies, based at least in part on a configuration, that a field is absent for a transmission of the control message.

Aspect 19: The method of aspect 14, wherein the reduced format version comprises an abstract syntax notation one format.

Aspect 20: A UE for wireless communications, comprising one or more memories storing processor-executable code, and one or more processors coupled with the one or more memories and individually or collectively operable to execute the code to cause the UE to perform a method of any of aspects 1 through 13.

Aspect 21: A UE for wireless communications, comprising at least one means for performing a method of any of aspects 1 through 13.

Aspect 22: A non-transitory computer-readable medium storing code for wireless communications, the code comprising instructions executable by one or more processors to perform a method of any of aspects 1 through 13.

Aspect 23: A network entity for wireless communications, comprising one or more memories storing processor-executable code, and one or more processors coupled with the one or more memories and individually or collectively operable to execute the code to cause the network entity to perform a method of any of aspects 14 through 19.

Aspect 24: A network entity for wireless communications, comprising at least one means for performing a method of any of aspects 14 through 19.

Aspect 25: A non-transitory computer-readable medium storing code for wireless communications, the code comprising instructions executable by one or more processors to perform a method of any of aspects 14 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive an encoded message comprising a first reduced format version of a control message comprising one or more parameters for configuring a wireless communication session, wherein the first reduced format version has a reduced payload compared to a non-reduced format version of the control message;
generate a second reduced format version based at least in part on the non-reduced format version and a value of the one or more parameters, wherein the second reduced format version has the reduced payload compared to the non-reduced format version;
decode a full payload of the control message based at least in part on the second reduced format version; and
communicate one or more messages based at least in part on the full payload of the control message.

2. The UE of claim 1, wherein, to receive the first reduced format version, the one or more processors are individually or collectively further operable to execute the code to cause the UE to:
receive the first reduced format version that comprises a main list and a plurality of extension lists, wherein the value of the one or more parameters indicates a quantity of elements in the main list and in each of the plurality of extension lists, and wherein the value of the one or more parameters is absent for the main list and for each of the plurality of extension lists.

3. The UE of claim 2, wherein the one or more processors are individually or collectively further operable to execute the code to cause the UE to:
receive, prior to generating the second reduced format version, a message indicating a configuration that indicates the value of the one or more parameters.

4. The UE of claim 3, wherein, to generate the second reduced format version, the one or more processors are individually or collectively further operable to execute the code to cause the UE to:
generate the second reduced format version based at least in part on generating the main list and each of the plurality of extension lists using the value of the one or more parameters.

5. The UE of claim 1, wherein, to receive the first reduced format version, the one or more processors are individually or collectively further operable to execute the code to cause the UE to:
receive the first reduced format version that comprises a main list and a plurality of extension lists, wherein the value of the one or more parameters indicates a quantity of elements in the main list and in each of the plurality of extension lists, and wherein the value of the one or more parameters is present for the main list and the value of the one or more parameters is absent for each of the plurality of extension lists.

6. The UE of claim 5, wherein, to generate the second reduced format version, the one or more processors are individually or collectively further operable to execute the code to cause the UE to:
generate the second reduced format version based at least in part on generating each of the plurality of extension lists using the value of the one or more parameters.

7. The UE of claim 1, wherein, to receive the first reduced format version, the one or more processors are individually or collectively further operable to execute the code to cause the UE to:
receive the first reduced format version that comprises an original list and one or more concatenated extension lists, wherein the value of the one or more parameters indicates a quantity of elements in the original list and in each of the one or more concatenated extension lists, and wherein the value of the one or more parameters is absent for the original list and for the one or more concatenated extension lists.

8. The UE of claim 7, wherein the one or more processors are individually or collectively further operable to execute the code to cause the UE to:
receive, prior to generating the second reduced format version, a message indicating a configuration that indicates the value of the one or more parameters, and wherein, to generate the second reduced format version, the one or more processors are individually or collectively further operable to execute the code to cause the UE to:
generate the second reduced format version of the control message based at least in part on generating the original list and each of the one or more concatenated extension lists using the value of the one or more parameters.

9. The UE of claim 1, wherein, to receive the first reduced format version, the one or more processors are individually or collectively further operable to execute the code to cause the UE to:
receive the first reduced format version that comprises an original list and one or more concatenated extension lists, wherein the value of the one or more parameters indicates a quantity of elements in the original list and in each of the one or more concatenated extension lists, and wherein the value of the one or more parameters is absent for the one or more concatenated extension lists, wherein, to generate the second reduced format version, the one or more processors are individually or collectively further operable to execute the code to cause the UE to:
generate the second reduced format version based at least in part on reconstructing each of the one or more concatenated extension lists using the value of the one or more parameters.

10. The UE of claim 1, wherein the first reduced format version comprises an abstract syntax notation one format.

11. The UE of claim 1, wherein the reduced payload comprises a reduced header size compared to the non-reduced format version of the control message.

12. The UE of claim 1, wherein the one or more processors are individually or collectively further operable to execute the code to cause the UE to:
receive, prior to communicating the one or more messages, side information indicating the value of the one or more parameters.

13. The UE of claim 12, wherein the side information comprises an encoding control notation format or an abstract syntax notation one format.

14. A method for wireless communications by a user equipment (UE), comprising:
receiving an encoded message comprising a first reduced format version of a control message comprising one or more parameters for configuring a wireless communication session, wherein the first reduced format version has a reduced payload compared to a non-reduced format version of the control message;
generating a second reduced format version based at least in part on the non-reduced format version and a value of the one or more parameters, wherein the second reduced format version has the reduced payload compared to the non-reduced format version;
decoding a full payload of the control message based at least in part on the second reduced format version; and
communicating one or more messages based at least in part on the full payload of the control message.

15. The method of claim 14, wherein receiving the first reduced format version further comprises:
receiving the first reduced format version that comprises a main list and a plurality of extension lists, wherein the value of the one or more parameters indicates a quantity of elements in the main list and in each of the plurality of extension lists, and wherein the value of the one or more parameters is absent for the main list and for each of the plurality of extension lists.

16. The method of claim 15, further comprising:
receiving, prior to generating the second reduced format version, a message indicating a configuration that indicates the value of the one or more parameters.

17. The method of claim 16, wherein generating the second reduced format version further comprises:
generating the second reduced format version based at least in part on reconstructing the main list and each of the plurality of extension lists using the value of the one or more parameters.

18. The method of claim 14, wherein receiving the first reduced format version further comprises:
receiving the first reduced format version that comprises a main list and a plurality of extension lists, wherein the value of the one or more parameters indicates a quantity of elements in the main list and in each of the plurality of extension lists, and wherein the value of the one or more parameters is present for the main list and the value of the one or more parameters is absent for each of the plurality of extension lists.

19. The method of claim 18, wherein generating the second reduced format version further comprises:
generating the second reduced format version based at least in part on generating each of the plurality of extension lists using the value of the one or more parameters.

20. A non-transitory computer-readable medium storing code for wireless communications, the code comprising instructions executable by one or more processors to:
receive an encoded message comprising a first reduced format version of a control message comprising one or more parameters for configuring a wireless communication session, wherein the first reduced format version has a reduced payload compared to a non-reduced format version of the control message;
generate a second reduced format version based at least in part on the non-reduced format version and a value of the one or more parameters, wherein the second reduced format version has the reduced payload compared to the non-reduced format version;
decode a full payload of the control message based at least in part on the second reduced format version; and
communicate one or more messages based at least in part on the full payload of the control message.
